(19) United States
(12) Patent Application Publication
(10) Pub. No.: US 2012/0074959 A1
(43) Pub. Date: Mar. 29, 2012

(54) COIN DETECTOR

(76) Inventors: Pin-Chia LEE, Taipei City (TW); Shao-Po Chan, Taipei City (TW); Ruei-Jia Huang, Taipei City (TW)

(21) Appl. No.: 13/309,051

(22) Filed: Dec. 1, 2011

(30) Foreign Application Priority Data
Feb. 1, 2011 (TW) 100103833

(51) Int. Cl. G01N 27/02

(52) U.S. Cl. 324/655

(57) ABSTRACT

A coin detector includes an oscillator circuit using an oscillator for generating a magnetizing signal of a predetermined oscillation frequency and an eddy current sensor for producing an AC magnetic field for sensing the variation of the inductance of an eddy current produced upon passing of a coin, a FM demodulator and an AM demodulator respectively electrically coupled to the oscillator circuit by a respective buffer for demodulating the voltage frequency and voltage amplitude of the oscillation signal outputted by the oscillator circuit, and a recognition logic unit for computing the demodulated FM signal outputted by the FM demodulator and the demodulated AM signal outputted by the AM demodulator by means of using time as a parameter to recognize the authenticity and value of the sensed coin.

This application claims the priority benefit of Taiwan patent application number 100103833 file on Feb. 1, 2011.

### BACKGROUND OF THE INVENTION

1. Field of the Invention

The present invention relates to coin detecting technology and more particularly, to a coin detector, which uses an eddy current sensor of an oscillation circuit to sense the variation of the inductance of an eddy current produced upon passing of a coin, a FM demodulator and an AM demodulator to demodulate the voltage frequency and voltage amplitude of the oscillation signal outputted by the oscillator circuit, and a recognition logic unit to combine the waveforms of the demodulated FM signal and demodulated AM signal by using time as a parameter for comparison with predetermined reference data to recognize the authenticity and value of the sensed coin accurately.

2. Description of the Related Art

Following fast development of social civilization and technology, people accelerate their pace of life and require a better quality of life. In consequence, various automatic vending machines are used everywhere to sell different products without serviceman, bringing convenience to people and helping suppliers save much labor cost. Following increasing of selling items, new automatic vending machines with added functions are created.

Further, regular automatic vending machines and game machines commonly use a coin acceptor for receiving coins so that a consumer can insert coins into an automatic vending machine or game machine to purchase commodities or to play games. The coin receiver of a coin-operated machine generally comprises a sensor module for recognizing the authenticity and value of every inserted coin. Because different coins or tokens may be used in different countries or different amusement parks and because different coins/tokens have different sizes and values, a sensor module must be able to recognize the authenticity and values of different coins/tokens. The recognition accuracy of the sensor module is relevant to the subsistence and profit of the business owner and the rights of consumers.

Conventional sensor modules commonly use a non-contact displacement sensor to sense metal coins/tokens. Among conventional non-contact displacement sensors, an eddy current sensor is most popularly used for the advantages of small size and operability under a high temperature environment or an environment having a high concentration of dust or pollutants. Subject to the material properties, regular metal coins/tokens can be classified into two groups, namely, the strong magnetic group (such as ferrite, copper nickel and the like) and the weak magnetic group (such as aluminum, lead, and the like). When an eddy current sensor is electrically connected to generate an oscillation frequency, an AC magnetic field will be produced for sensing different metal materials and for inducing an eddy current upon passing of a metal coin. The distance between the coin and the eddy current sensor, the geometric configuration (size and thickness) of the coin and the magnetic permeability of the material of the coin can cause change of the inductance value of the induced eddy current. Therefore, when a different metal coin passes as the eddy current is generating a constant oscillation frequency, the inductance of the induced eddy current will be different. By means of comparing the inductance of the induced eddy current with a predetermined reference value, the authenticity of the sensed metal coin is recognized.

Subject to the operation principle of the aforesaid eddy current sensing type displacement sensor, it is known that the variation produced upon passing of a metal coin can be expressed by voltage or current, and the sensor circuit can be an AM (amplitude modulation) circuit or FM (frequency modulation) circuit. An AM (amplitude modulation) circuit is adapted for sensing the variation of the voltage amplitude caused by the sensor's equivalent resistance and equivalent current. A FM (frequency modulation) circuit is adapted for sensing the variation of the frequency caused by the sensor's equivalent inductance. However, the frequency of a FM circuit is not constant, and the skin depth varies with the frequency of the applied wave. When at a low magnetizing frequency (such as 0.5-2 MHz), electrical runout of the metal material of the coin affects the sensing of a FM circuit relatively greater than an AM circuit. In this case, the sensing accuracy of a FM circuit is relatively lower than an AM circuit. Normally, the higher the magnetizing frequency is, the lower the skin depth and the electrical runout will be. However, increasing the magnetizing frequency will complicate the posterior signal processing process, causing increase of the total cost. Further, by means of limiting the amplitude, an AM circuit can eliminate parasitic amplitude modulation caused by noises to avoid distortion. However, because the waveform of an amplitude-modulated signal in an AM circuit is variable, the method of amplitude limitation is not applicable. Further, the bandwidth of a FM circuit is greater than an AM circuit and its power utilization rate is also relatively higher than an AM circuit. Thus, a FM circuit and an AM circuit have their merits and demerits. Designing a sensor circuit that combines the advantages of a FM circuit and an AM circuit can improve coin authenticity and value recognition accuracy.

### SUMMARY OF THE INVENTION

The present invention has been accomplished under the circumstances in view. It is therefore an object of the present invention to provide a coin detector for recognizing the authenticity and value of a coin, which combines FM (frequency modulation) sensing techniques and AM (amplitude modulation) sensing techniques to effectively improve the stability and accuracy of the recognition of the authenticity and value of a metal coin.

To achieve this and other objects of the present invention, a coin detector comprises an oscillator circuit using an oscillator for generating a magnetizing signal of a predetermined oscillation frequency and an eddy current sensor for producing an AC magnetic field for sensing the variation of the inductance of an eddy current produced upon passing of a coin, a FM demodulator and an AM demodulator respectively electrically coupled to the oscillator circuit by a respective buffer for demodulating the voltage frequency and voltage amplitude of the oscillation signal outputted by the oscillator circuit, and a recognition logic unit for computing the demodulated FM signal outputted by the FM demodulator and the demodulated AM signal outputted by the AM demodulator by means of using time as a parameter function to recognize the authenticity and value of the sensed coin.

Further, the oscillation signal outputted by the oscillation circuit and the demodulated FM signal AM signal can be represented in phasor diagram. Thus, there is a phase difference between the oscillation signal thus obtained and the original oscillation signal. By combining the parameter function, recognition of the authenticity and value of the sensed coin is accurately done. Further, the invention maintains the characteristics of the demodulated FM signal and the characteristics of the demodulated AM signal.

The recognition logic unit combines the waveform of the demodulated FM signal and the waveform of the demodulated AM signal and then converts the combined waveform into a modal diagram by using time as a parameter, and then calculates and assorts the distribution and characteristics of the combined waveforms to fetch the maximum values and turning points along the X-axis and/or vertical axis for comparison with predetermined reference values to recognize the authentic and value of the sensed coin

### BRIEF DESCRIPTION OF THE DRAWINGS

FIG. 1 is a circuit block diagram of a coin detector in accordance with the present invention.

FIG. 2 is a waveform curve of the demodulated FM signal outputted by the FM demodulator of the coin detector in accordance with the present invention.

FIG. 3 is a waveform curve of the demodulated AM signal outputted by the AM demodulator of the coin detector in accordance with the present invention.

FIG. 4 is a waveform curve illustrating the waveform of the demodulated FM signal and the waveform of the demodulated AM signal in accordance with the present invention.

FIG. 5 is a modal diagram of the demodulated FM signal and the demodulated AM signal in accordance with the present invention.

FIG. 6 is an oscillation signal phasor diagram in accordance with the present invention.

### DETAILED DESCRIPTION OF THE PREFERRED EMBODIMENT

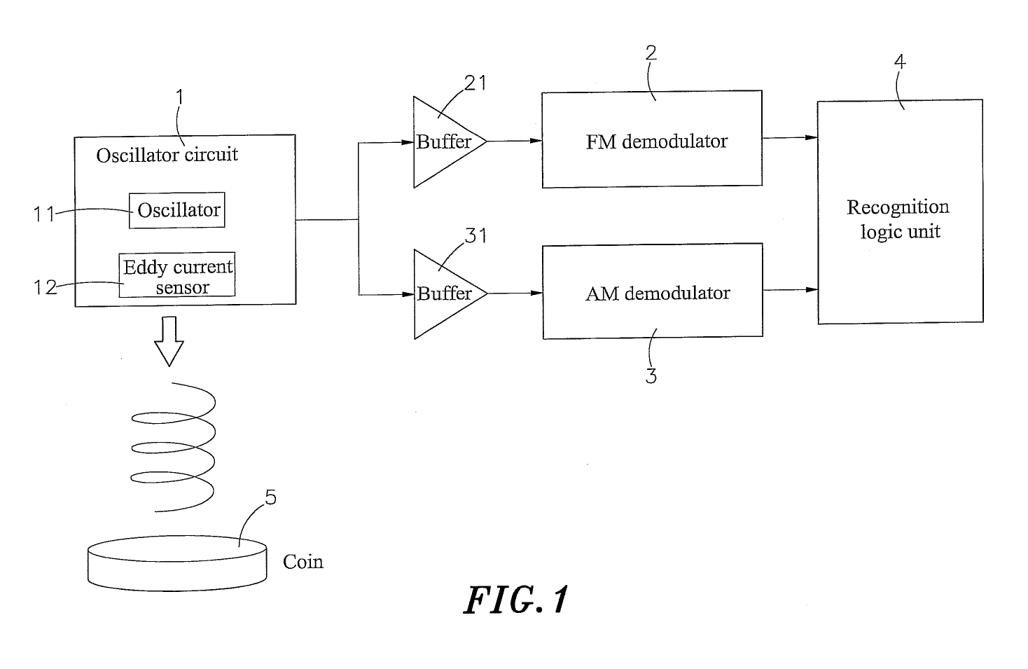

Referring to FIG. 1, a coin detector in accordance with the present invention is shown comprising an oscillator circuit 1, a FM demodulator 2, an AM demodulator 3 and a recognition logic unit 4.

The oscillator circuit 1 comprises an oscillator 11 for generating a magnetizing signal of a predetermined oscillation frequency f, and an eddy current sensor 12 electrically connected with the oscillator 11 and adapted for receiving the magnetizing signal from the oscillator 11 and producing an AC magnetic field for sensing the variation of the inductance of the eddy current produced upon passing of a coin 5 and then causing the oscillator circuit 1 to output a corresponding oscillation signal F. The FM demodulator 2 is electrically coupled to the output terminal of the oscillator circuit 1 by means of a buffer 21, and adapted for demodulating the voltage frequency of the oscillation signal F and then outputting a corresponding demodulated FM signal X. The AM demodulator 3 is electrically coupled to the output terminal of the oscillator circuit 1 by means of a buffer 31, and adapted for demodulating the voltage amplitude of the oscillation signal F and then outputting a corresponding demodulated AM signal Y.

Further, the oscillator 11 of the oscillator circuit 1 can be, but not limited to, an LC oscillator circuit, such as Colpitts oscillator, Hartley oscillator, or any resonant circuit capable of generating a predetermined oscillation frequency f=1/[2π√(LC)]. In this case, the Colpitts oscillator is a LC oscillator using an equivalent inductance (L) of the eddy current sensor 12 and two capacitors (C) in parallel for frequency determination; the Hartley oscillator is an electric oscillator circuit using a tapped inductor and a variable capacitor in parallel to determine the frequency. By means of providing a frequency-stabilized high-frequency magnetizing signal, the oscillation frequency f of the oscillator 11 is well controlled.

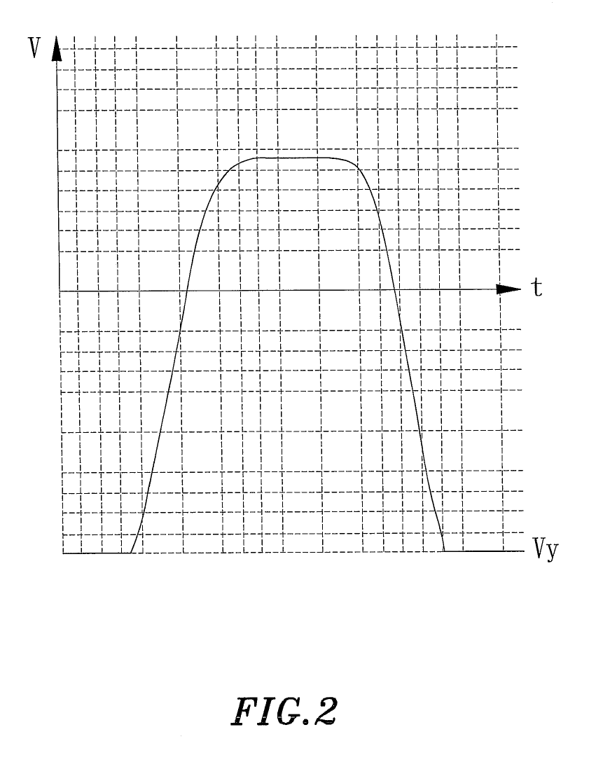

Referring to FIGS. 4, 5 and 6, and FIG. 1 again, the coin detector can be installed in an automatic vending machine, game machine (not shown) or any of a variety of other consumer systems that provide commodities and/or services to sense the authenticity and value of an inserted coin 5. When a user inserted a coin 5 into a coin slot on a face panel of the machine, the coin 5 immediately runs along a coin slot to coin sensing zone in the machine. At this time, the oscillator 11 of the oscillator circuit 1 generates a magnetizing signal of a predetermined oscillation frequency f, and the eddy current sensor 12 is induced by the magnetizing signal from the oscillator 11 to produce an AC magnetic field for sensing the variation of the inductance of the eddy current produced upon passing of the coin 5 and then causing the oscillator circuit 1 to output a corresponding oscillation signal F. Due to energy loss caused during passing of the coin 5 through the AC magnetic field induced by the eddy current sensor 12, the oscillation frequency f of the oscillation signal F outputted by the oscillator circuit 1 is relative changed. The frequency value f+Δf of the oscillation frequency f can be obtained subject to the oscillation frequency equation f+Δf=1/{2π√[(L+ΔL)C]}, in which the inductance value L+ΔL of the equivalent inductance L is determined subject to the variation of the eddy current induced by the eddy current sensor 12; the oscillation frequency f of the oscillation signal F is demodulated by the FM demodulator 2 to amplify the signal so that the FM demodulator 2 outputs a demodulated FM signal X of which the waveform Vx of the demodulated FM signal X is described in FIG. 2 in which the horizontal axis (t) indicates the time; the vertical axis (V) indicates the demodulated output voltage.

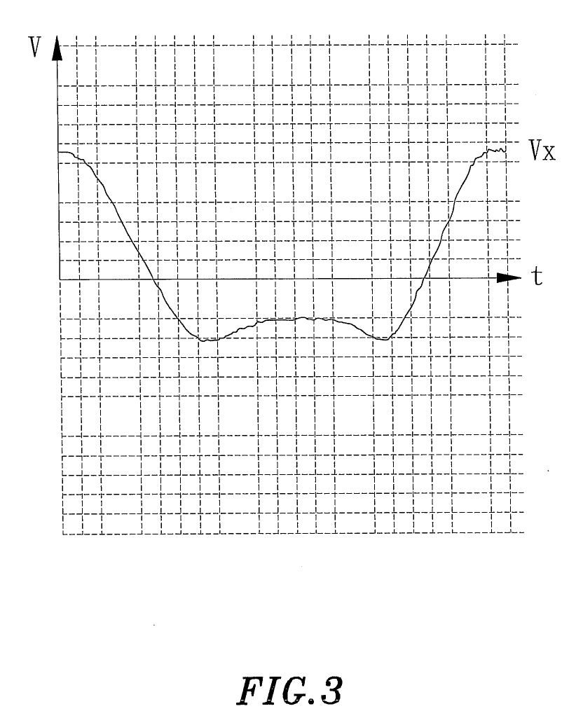

Further, variation of the oscillation signal F outputted by the oscillator circuit 1 causes variation of the oscillation amplitude. The oscillation peak of the oscillation signal F is demodulated by an envelope detector or the aforesaid AM demodulator 3. The waveform Vy of the demodulated AM signal Y thus obtained is described in FIG. 3 in which the horizontal axis (t) indicates the time; the vertical axis (V) indicates the output voltage.

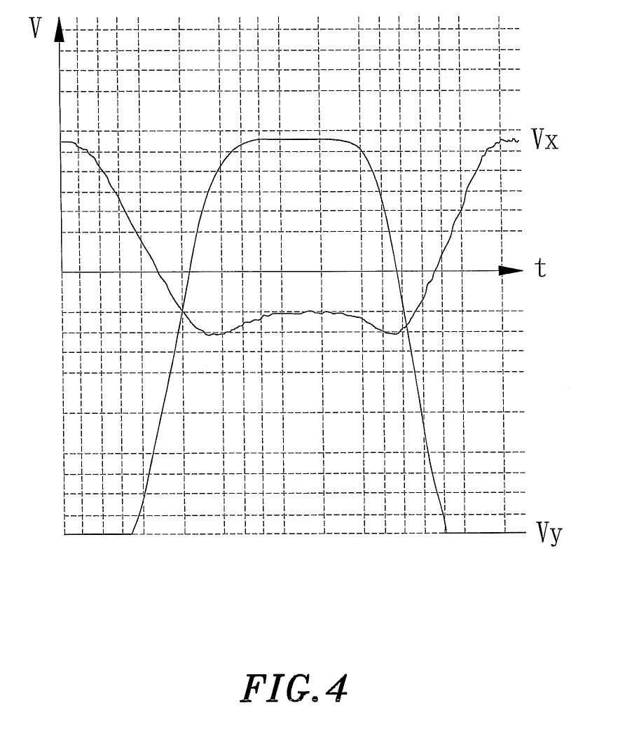

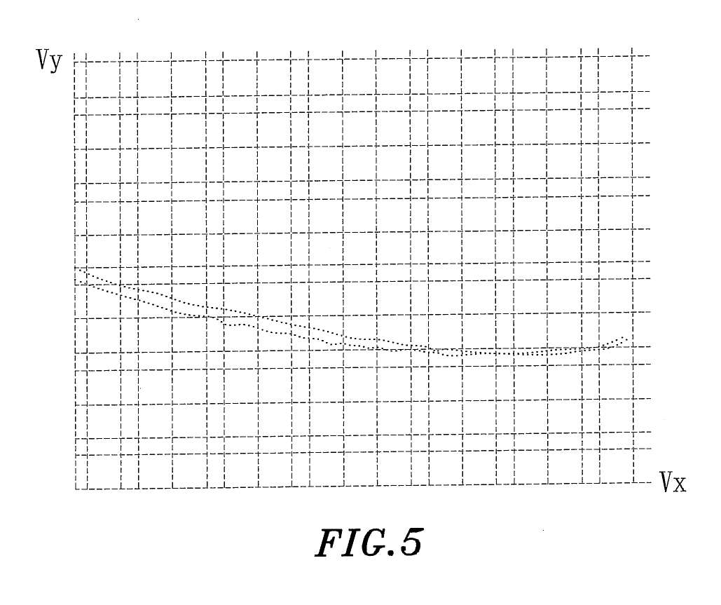

If there is no any coin passing through the coin passage of the machine, the inductance value of the eddy current sensed by the eddy current sensor 12 remains unchanged. When a coin 5 passes through the coin passage of the machine, the distance between the coin 5 and the eddy current sensor 12, the geometric configuration (size and thickness) of the coin 5 and the magnetic permeability of the material of the coin 5 can cause change of the inductance value of the eddy current, and the voltage amplitude of the sine wave oscillation signal F outputted by the oscillator circuit 1 will be reduced, and the frequency will be relatively accelerated or slowed down. Thus, the eddy current sensor 12 must sense the coin 5 within a short measuring distance, limiting the sensor bandwidth and affecting the coin recognition accuracy. The invention eliminates the aforesaid problem by employing AM and FM demodulation techniques to recognize the authenticity and value of the sensed coin. The waveform Vx of the demodulated FM signal X and the waveform Vy of the demodulated AM signal Y are combined, as shown in FIG. 4, and then converted into a modal diagram, as shown in FIG. 5, by the aforesaid recognition logic unit 4 by using time as a parameter and using a software library to execute software logic operations. In the modal diagram shown in FIG. 5, the horizontal axis is the waveform Vx of the demodulated FM signal X; the vertical axis is the waveform Vy of the demodulated AM signal Y. By means of calculating and assorting the output voltage difference obtained subject to combination of the demodulated FM signal X and the demodulated AM signal Y with the use of time as a parameter as well as calculating and assorting the distribution and characteristics of the combined waveforms at the same time, the maximum values and turning points along the X-axis and/or vertical axis are fetched for comparison with predetermined reference values to recognize the authentic and value of the sensed coin 5. If the sensed coin 5 is recognized to be a counterfeit coin, the counterfeit coin will be guided through a gate along a coin-return passage toward a coin-return slot. If the sensed coin 5 is recognized to be an authentic coin, the gate will be moved by an electromagnetic valve, enabling the authentic coin to fall through a coin outlet to a coin box in the machine.

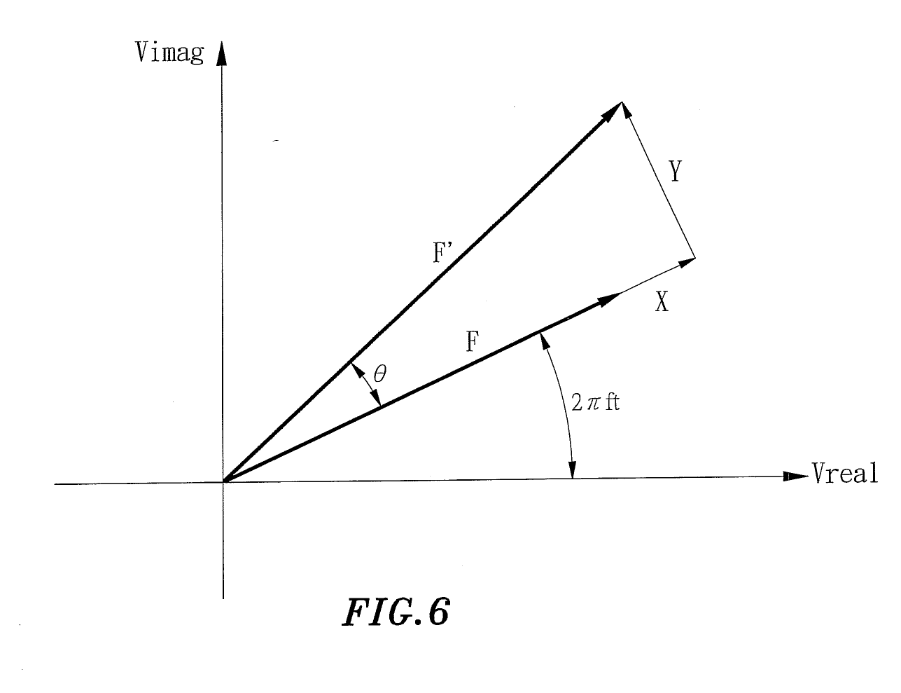

In the oscillation signal phasor diagram shown in FIG. 6, the horizontal axis is the real vector (Vreal), and the vertical axis is the imaginary vector (Vimag). After demodulation of the oscillation signal F, the vector of the outputted demodulated FM signal X and the vector of the outputted demodulated AM signal Y are in a perpendicular relationship; the vector of the oscillation signal F outputted by the oscillator circuit 1, the vector of the demodulated FM signal X and the vector of the demodulated AM signal Y can be expressed by the vector angle θ=tan⁻¹[Y/(F+X)] of the oscillation signal F′ of angle of amplitude, so that the vector of the oscillation signal F′ and the vector of the original oscillation signal F produce a certain range of difference. Thus, by means of comparing the variance of the change of vector angle of the waveform of the demodulated FM signal X and the waveform of the demodulated AM signal Y based on the parameter of time, the output voltage difference, and related distribution condition and characteristics and other parameters produced at the same time by the combination of the aforesaid waveforms with respective reference values, recognition of the authenticity and value of the sensed coin 5 is accurately done. Further, the invention maintains the characteristics of the demodulated FM signal X and the characteristics of the demodulated AM signal Y.

In conclusion, the invention provides a coin detector comprising an oscillator circuit 1, which comprises an oscillator 11 for generating a magnetizing signal of a predetermined oscillation frequency f, and an eddy current sensor 12 electrically connected with the oscillator 11 for sensing the variation of the inductance of the eddy current produced upon passing of a coin 5, a FM demodulator 2 electrically coupled to the oscillator circuit 1 by means of a buffer 21 for demodulating the voltage frequency of the oscillation signal F outputted by the oscillator circuit 1, an AM demodulator 3 electrically coupled to the output terminal of the oscillator circuit 1 by means of a buffer 31 for demodulating the voltage amplitude of the oscillation signal F outputted by the oscillator circuit 1, and a recognition logic unit 4 electrically coupled with the output terminal of the FM demodulator 2 and the output terminal of the AM demodulator 3 for computing the demodulated FM signal X outputted by the FM demodulator 2 and the demodulated AM signal Y outputted by the AM demodulator 3 by means of overlapping the waveform of the demodulated FM signal X and the waveform of the demodulated AM signal Y and using time as a parameter, and therefore the authenticity and value of the sensed coin 5 are accurately recognized.

It is to be understood that the above-described embodiments of the invention are merely possible examples of implementations, merely set forth for a clear understanding of the principles of the invention, many modifications and enhancements may be made without departing from the spirit and scope of the invention. Accordingly, the invention is not to be limited except as by the appended claims.

What the invention claimed is:

1. A coin detector used in a coin-operated machine for detecting the authentic and value of a coin, comprising:
an oscillator circuit, said oscillator circuit comprising an oscillator for generating a magnetizing signal of a predetermined oscillation frequency and an eddy current sensor electrically connected with said oscillator and adapted for receiving the magnetizing signal from said oscillator and producing an AC magnetic field for sensing the variation of the inductance of an eddy current produced upon passing of a coin and then causing said oscillator circuit to output a corresponding oscillation signal;
a FM demodulator electrically coupled to said oscillator circuit by means of a buffer and adapted for demodulating the voltage frequency of the oscillation signal outputted by said oscillator circuit and then outputting a corresponding demodulated FM signal;
an AM demodulator electrically coupled to said oscillator circuit by means of a buffer and adapted for demodulating the voltage amplitude of the oscillation signal outputted by said oscillator circuit and then outputting a corresponding demodulated AM signal; and
a recognition logic unit electrically coupled with said FM demodulator and said AM demodulator for computing the demodulated FM signal outputted by said FM demodulator and the demodulated AM signal outputted by said AM demodulator by means of using time as a parameter to recognize the authenticity and value of the sensed coin.

2. The coin detector as claimed in claim 1, wherein said oscillator of said oscillator circuit is an inductance-capacitance oscillator.

3. The coin detector as claimed in claim 1, wherein said oscillator of said oscillator circuit is selected from the group of Colpitts oscillator, Hartley oscillator, resonant circuits capable of generating a predetermined oscillation frequency

4. The coin detector as claimed in claim 1, wherein said recognition logic unit combines the waveform of the demodulated FM signal outputted by said FM demodulator and the waveform of the demodulated AM signal outputted by said AM demodulator and uses time as a parameter to compute the voltage difference, calculates and assorts the distribution and characteristics of the combined waveforms at the same time, and fetches the maximum values and turning points in the horizontal axis and/or the vertical axis for comparison with predetermined reference values to recognize the authentic and value of the sensed coin.
